(19) United States
(12) Patent Application Publication
(10) Pub. No.: US 2009/0014340 A1
(43) Pub. Date: Jan. 15, 2009

(54) DEVICES, SYSTEMS, AND METHODS FOR MEASURING GLUCOSE

(76) Inventors: John R. Williams, Lexington, MA (US); Angela M. Zapata, Redwood City, CA (US); Nina Mahealani Heinrich, Redwood City, CA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/138,827

(22) Filed: Jun. 13, 2008

Related U.S. Application Data
(60) Provisional application No. 60/944,207, filed on Jun. 15, 2007.

(51) Int. Cl. G01N 27/27; G01N 27/416; G01N 27/26; C07F 5/02

(52) U.S. Cl. 205/787; 204/402; 562/7

(57) ABSTRACT

Systems and methods for detecting glucose in a sample using, for example, a regenerable sensor are described. The sensor may, for example, include boronic acid to detect with great sensitivity and at a low cost the glucose in the sample.

### CROSS-REFERENCE TO RELATED APPLICATION

This application claims the benefit of and priority to U.S. Provisional Patent Application No. 60/944,207, filed Jun. 15, 2007, the disclosure of which is hereby incorporated herein by reference in its entirety.

### TECHNICAL FIELD

The invention relates, in various embodiments, to systems and methods for measuring glucose in a sample using a regenerable sensor.

### BACKGROUND

One important aspect in the treatment of diabetes is the tight control of blood glucose levels, which typically requires frequent monitoring of blood glucose levels of patients so as to manage food intake and the dosage and timing of insulin injection. Currently, millions of diabetics are forced to draw blood daily to determine their blood sugar levels. To alleviate the expense, constant discomfort, and inconvenience to these individuals, substantial efforts have been undertaken to search for low cost and minimally invasive technologies to accurately determine blood glucose levels.

Current methods and systems for measuring glucose in a sample include fluorescence spectroscopy, infrared spectroscopy, measurement of hydrogel swelling, polarimetry, Raman spectroscopy, and electrochemical sensors that utilize glucose oxidase-catalyzed conversion of glucose to gluconic acid and hydrogen peroxide. Systems based upon glucose oxidase can, however, exhibit long-term drift problems. In addition, glucose in a sample has been measured by binding it to a molecular receptor, for example concanavalin, bacteria, artificial receptors, and others, and obtaining an indirect measurement, such as from a corresponding optical event. For example, the release of fluorescently labeled molecules from the receptor upon binding of glucose to the receptor has been used to indirectly measure glucose in a sample.

Existing reusable systems for measuring glucose in a sample typically require expensive spectrometers and therefore tend to be costly. In addition, they are generally impractical for daily use by, for example, a diabetic. Nonreuseable systems such as disposable strips are expensive, costing about $1.00 per use, which may result in a high rate of noncompliance by diabetics who need to monitor their glucose levels multiple times per day. Typical systems and methods also require that the finger be pricked to obtain an adequate amount of blood for the sensor and preclude the possibility of utilizing a smaller sample taken from a less sensitive area.

Accordingly, there is a need for a glucose detection system that does not require expensive readouts, is reusable and less costly, and which is more sensitive than currently available systems.

### SUMMARY OF THE INVENTION

In various embodiments, the present invention addresses these limitations by using a regenerable glucose sensor that includes a molecular receptor, such as boronic acid, to detect with great sensitivity, and at a low cost, the glucose in a sample. More specifically, in one embodiment, a regenerable sensor for measuring glucose in a sample includes a diaphragm having a conductive portion. A molecular receptor, capable of reversibly binding to the glucose, is coated on a first face of the diaphragm. The regenerable sensor also includes a counterelectrode spaced from and in opposition to the diaphragm. The diaphragm deforms and alters a capacitance of the regenerable sensor upon binding of the glucose to the molecular receptor. Accordingly, the bound glucose may be measured according to deformation of a moveable portion of the sensor, rather than, for example, by measurement of fluorescence or absorbance of a molecule that competes with or labels glucose bound to the sensor.

The regenerable sensor may also include means for regenerating the first face of the diaphragm by removing the glucose bound to it, and/or means for introducing blood to the first face of the diaphragm. In certain embodiments, the molecular receptor includes a boronic acid. The conductive portion of the diaphragm may, for example, include gold or silicon. In certain embodiments, the sensitivity of measurement allows for a small sample volume, for example about 0.5-2.0 microliters of sample volume, such as 1 microliter of sample volume, to be used.

In another aspect, embodiments of the invention feature a method for measuring glucose in a sample, such as a blood sample. First, the sample is exposed to a sensor that includes boronic acid bound to a moveable surface of the sensor. Next, the glucose reversibly bound to the boronic acid is measured (e.g., by observing a deformation of the moveable surface and/or by observing a change in the capacitance of the sensor). Following the measuring, the moveable surface is regenerated by removing the glucose bound to the boronic acid. In certain embodiments, the moveable surface is regenerated by flowing a buffer solution over the moveable surface, by exposing the moveable surface to a glycol, and/or by oxidizing the glucose bound to the boronic acid.

In some samples (e.g., blood), one or more interfering compounds (e.g., molecules, diols, sugars and/or carbohydrates other than glucose) may be present and interfere with the quantitative and/or qualitative measurement of the glucose in the sample. Accordingly, embodiments of the present invention also feature methods and devices for determining an amount of glucose in a sample that also includes an interfering compound. For example, in accordance with one embodiment, a sample that includes glucose and an interfering compound is exposed to a first sensor having a first molecular receptor that is capable of binding the glucose and the interfering compound. The sample is also exposed to a second sensor having a second molecular receptor that is capable of binding the glucose and the interfering compound. The second molecular receptor has, however, a different binding constant than the first molecular receptor for at least one of the glucose and the interfering compound. The total amount of glucose and interfering compound, bound to each of the first and second molecular receptors, is then measured and the amount of glucose in the sample calculated. In certain embodiments, at least one of the first and second molecular receptors includes boronic acid or a derivative thereof. Measuring the total amount of glucose and interfering compound may include measuring a change in capacitance of one or each of the first and second sensors. Various devices may be used for obtaining such measurements.

In one such device, a first sensor includes a first surface having separate binding constants for each of the glucose and the interfering compound, and a second sensor includes a second surface having separate binding constants for each of the glucose and the interfering compound. At least one binding constant for the second surface is different from the corresponding binding constant for the first surface. In certain embodiments, at least one of the first sensor surface and the second sensor surface is a moveable surface. The moveable surface can include a conductive portion and a boronic acid or derivative thereof may be coated on the moveable surface. Interaction of the boronic acid and/or derivative thereof with the glucose and/or the interfering compound deforms the moveable surface and creates a measurable change in the capacitance of the sensor. In certain embodiments, the device further includes memory for storing binding constants of the glucose and the interfering compound and/or circuitry for calculating the amount of the glucose and/or the interfering compound present in the sample.

It is to be understood that the features of the various embodiments described herein are not mutually exclusive and may exist in various combinations and permutations.

### BRIEF DESCRIPTION OF THE DRAWINGS

The foregoing and other objects, aspects, features, and advantages of embodiments of the invention will become more apparent and may be better understood by referring to the following description and claims, taken in conjunction with the accompanying drawings, in which:

FIG. 1 depicts a perspective sectional view of one embodiment of a regenerable glucose sensor;

FIG. 2A depicts a general scheme for one embodiment of a glucose sensor in which immobilized boronic acid is used to detect glucose or another compound having a diol group;

FIG. 2B depicts a general scheme for one embodiment of a glucose sensor in which a thiol-immobilized phenylboronic acid monolayer is used to detect glucose via the phenylboronic acid-glucose adduct;

FIGS. 3A and 3B depict six exemplary molecular receptors that each include boronic acid and are bound to a surface;

FIG. 3C depicts two exemplary boronic acid compounds that can serve as ligands for glucose detection;

FIGS. 4A and 4B depict an exemplary stepwise formation of an amino-boronic acid monolayer on a surface following treatment of the surface with dithiobis-succinimidylpropionate (hereinafter “DSP”);

FIG. 4C depicts an exemplary boronic acid compound that can be attached to a surface in a single step;

FIG. 5 is a graph showing the rate of formation of a self-assembled monolayer in one embodiment of the invention;

FIG. 6 depicts an exemplary chemical scheme for chemically preparing a boronic acid with affinity for glucose at physiological pH;

FIG. 7A depicts a schematic overview of an exemplary embodiment of a system having ten regenerable sensors for detecting glucose in a sample;

FIG. 7B depicts a schematic overview of another exemplary embodiment of a system having one or more regenerable glucose sensors;

FIG. 8 depicts a plan view of one embodiment of a coated conductive moveable surface; and

FIG. 9 depicts one embodiment of a detection circuit useful in conjunction with the regenerable glucose sensor system.

### DESCRIPTION

In various embodiments, the invention relates to devices and methods for measuring glucose in a sample using a regenerable sensor. The regenerable glucose sensor features several advantages over former methods of measuring glucose in a sample. For example, in various embodiments, the regenerable glucose sensor has greater sensitivity than former methods, requires less sample volume, avoids employing expensive optical readout devices, and is less costly. In addition, the sensor may be regenerated at an insignificant cost by, for example, rinsing it with a buffer solution, which allows it to be used repeatedly and at a lower cost per test.

Most existing disposable glucose test strips are not reusable, which results in high yearly cost. For example, using disposable test strips can cost a user in excess of $1,825 per year (assuming a cost of $1/test and a consumption rate of 5 tests/day or 1,825 tests/year). The regenerable sensor described herein, however, can form part of an integrated system and provide significant cost savings. For example, again assuming a consumption rate of 5 tests/day or 1,825 tests/year, a one time cost of $50-$200 for the integrated system and $5 for each chip comprising ten sensor elements, with each sensor element capable of being re-used twenty-five times, leads to an annual cost that is less than $250 for the first year and less than $50 per year thereafter.

In one embodiment, the regenerable glucose sensor of the present invention does not rely upon an optical measurement (e.g. fluorescence), a labeling technique (e.g. fluorescence) or an enzyme (such as glucose oxidase), which may denature over time and cause sensor drift, to identify glucose bound to a sensor. Rather, certain embodiments of the regenerable glucose sensor employ a selective coating, for example a self-assembled monolayer applied to the face of a surface (e.g., a conductive and/or moveable surface, such as a diaphragm), that selectively and reversibly binds to glucose. The monolayer may include, for example, boronic acid. In addition, a readout system may be employed together with the sensor.

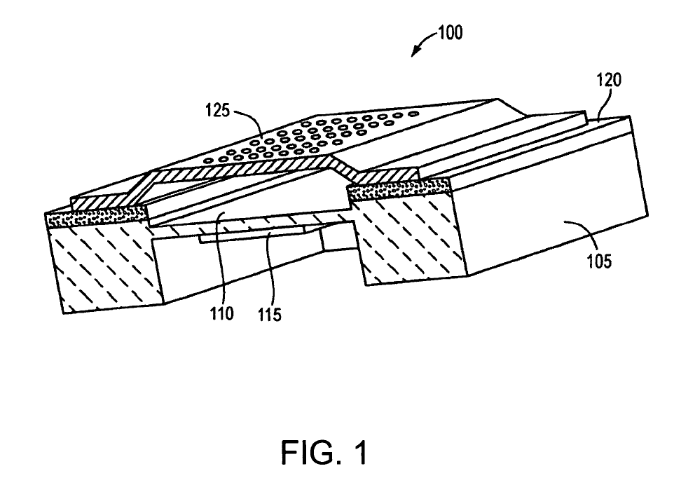

One embodiment of a regenerable glucose sensor is shown in FIG. 1. As illustrated, the sensor 100 includes a fixture or substrate 105, which secures the edges of a conductive moveable surface 110 (e.g., a diaphragm 110 that includes a conductive portion). The conductive moveable surface 110 may be circular, rectangular (as illustrated), or another shape. As used herein, the term “conductive” means electrically conductive or semiconductive, as those terms are understood in the art. A selective coating 115 is applied to the bottom face of the conductive moveable surface 110. Since the conductive moveable surface 110 and its support by the substrate 105 are continuous, selective coating 115 resides within a cavity formed by the substrate 105. An insulating layer 120 (e.g., a coating of rubber, plastic, or an oxide) is provided on a top surface of substrate 105. A counter electrode 125 is secured to the insulating layer 120 in opposition to the conductive moveable surface 110, thereby forming a gap between the conductive moveable surface 110 and the counter electrode 125.

It is generally important to maintain equal pressure on both sides of the conductive moveable surface 110 during operation. One or more of several approaches may be followed in this regard. As illustrated in FIG. 1, the counter electrode 125 may be perforated. Moreover, substrate 105 may include one or more apertures or valves; desirably, these are placed outside the coating and conductive moveable surface area where they will not interfere with movement (e.g., deflection) of the conductive moveable surface 110. Alternatively, conductive moveable surface 110 may not be attached to the substrate on all sides. The resulting gap between substrate 105 and a portion of the conductive moveable surface 110 serves to equalize pressure on both sides of the conductive moveable surface 110.

The conductive moveable surface 110 can be formed of any conductive material (e.g., a metal, such as gold, a pigment-loaded polymer, or a semiconductor, such as silicon) that is capable of withstanding repeated stresses at a thickness level small enough to undergo measurable deformation as a result of analyte interactions with the coating 115. Moreover, it is preferred that the conductive moveable surface 110 be compositionally uniform throughout its extent, since, for example, having multiple layers with different thermal-response properties will produce thermal distortion.

The structure 100 can be fabricated in many ways, for example by micromachining or by conventional silicon-processing techniques. For example, the conductive moveable surface 110 and substrate 105 may be created from standard six-inch silicon wafers using masking and reactive-ion etching techniques. Conventional oxidation and masking can be used to form insulating layer 120. A representative device may be, for example, 500 μm long, 1000 μm wide, and 1.5 μm thick.

Selective coating 115 may comprise a chemical moiety that binds to an analyte of interest. The moiety may be or reside on a polymer, a nucleic acid, a polypeptide, a protein nucleic acid, a substrate interactive with a polypeptide (e.g., an enzyme), an enzyme interactive with a substrate, an antibody interactive with an antigen, an antigen interactive with one or more antibodies, or other molecule. In certain embodiments, the selective coating 115 includes a molecular receptor capable of reversibly binding to glucose. For example, the coating 115 may include boronic acid, such as a multitude of ligands attached in a monolayer to the conductive moveable surface 110 and each including boronic acid. As used herein, the term boronic acid is understood to include boronic acid, any substituted boronic acid, and/or any derivative thereof that reversibly binds to glucose.

Accordingly, in certain embodiments, the regenerable sensor 100 includes a conductive moveable surface 110 having an immobilized glucose receptor coated thereon or bound thereto. As further described below in Section C, the glucose reversibly bound to the molecular receptor (e.g., boronic acid) of the coating 115 may be measured by observing a deformation of the conductive moveable surface 110, or, equivalently, a change in capacitance of the sensor 100.

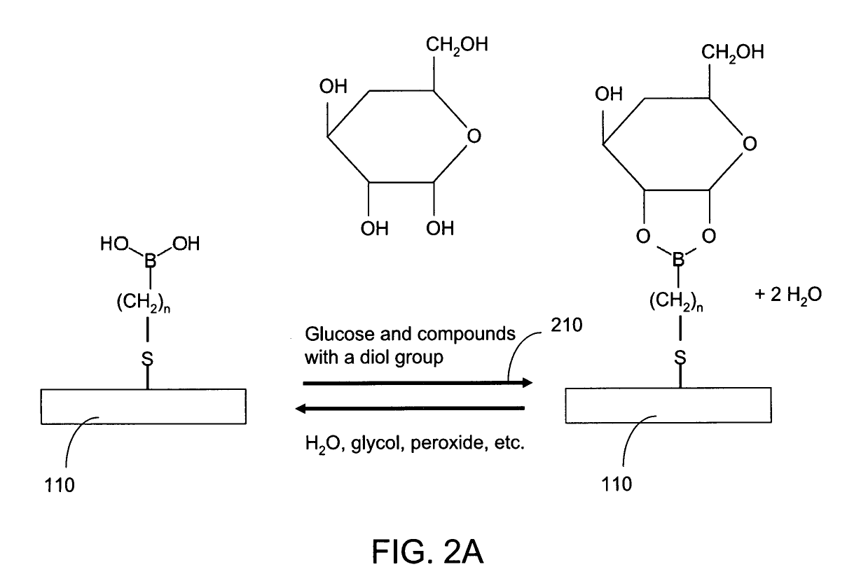

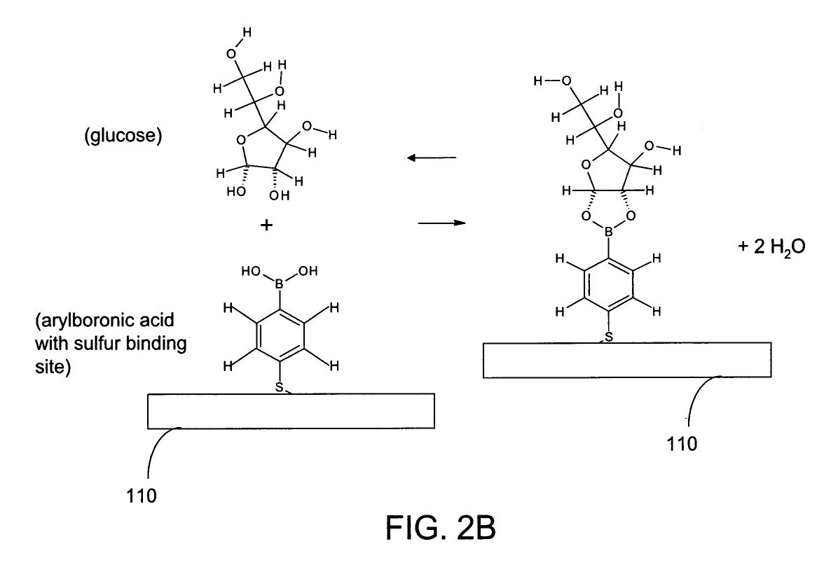

Boronic acid selectively and reversibly binds to diols, for example 1,2- or 1,3-diols, such as sugars. More specifically, as illustrated in FIGS. 2A and 2B, two covalent bonds are formed between each of the two hydroxyl groups on the boronic acid and each of two hydroxyl groups on the diol (e.g., glucose). The reactions each produce two molecules of water. Accordingly, these bonds are reversible, for example by the addition of water. More particularly, FIG. 2A schematically depicts an exemplary conductive moveable surface 110 for the sensor 100 in accordance with one embodiment of the present invention. As illustrated, a glucose receptor that includes boronic acid is immobilized to the conductive moveable surface 110. Moving in the direction of arrow 210, the receptor may bind to glucose and other compounds with a diol group. The binding, however, is reversible by applying, for example, water, glycol, and/or peroxide to the receptor to remove therefrom the glucose or other compound with a diol group. For its part, FIG. 2B schematically depicts another exemplary conductive moveable surface 110 in which an immobilized arylboronic acid monolayer is used to reversibly bind glucose via a phenylboronic acid-glucose adduct.

### A. Immobilizing the Boronic Acid to the Conductive Moveable Surface of the Sensor

A variety of immobilization techniques may be used to immobilize the boronic acid to the conductive moveable surface 110 of the sensor 100. As used herein, the terms and concepts of “immobilized,” “attached,” and/or “bound” ligand (e.g. boronic acid) are interchangeable. The attachment can be non-covalent or covalent. For example, where the conductive moveable surface 110 is a gold surface, sulfur-containing groups can be used to covalently form a self-assembled monolayer on the gold surface. Sulfur-containing compounds can include, for example, disulfides, thiols (mercaptans), and other sulfur-containing compounds. In the case of a conductive moveable surface 110 made of silicon or silicon dioxide, a silane can be used as an intermediary between the silicon and the boronic acid.

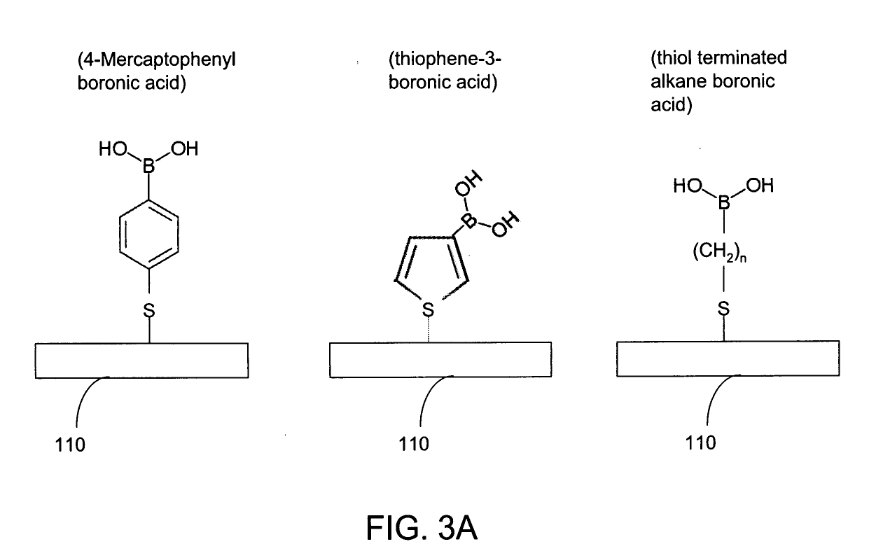

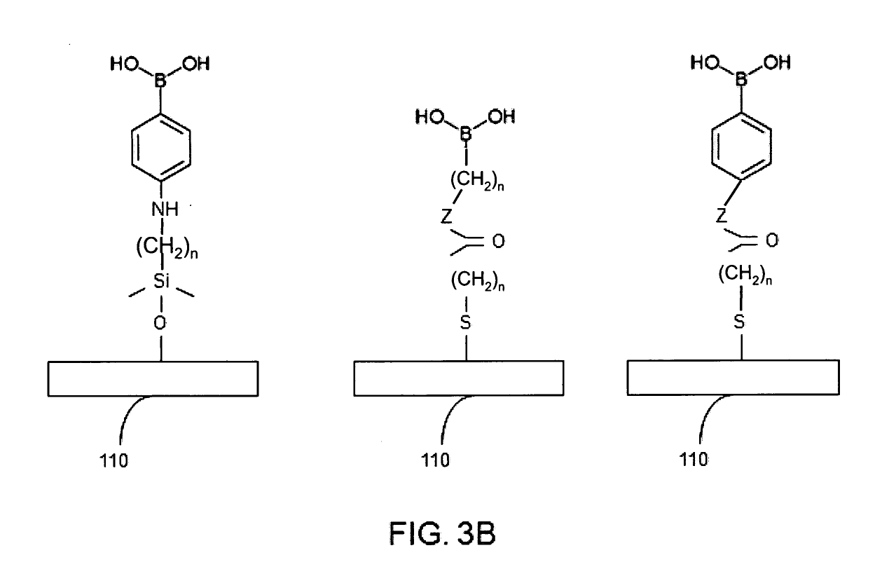

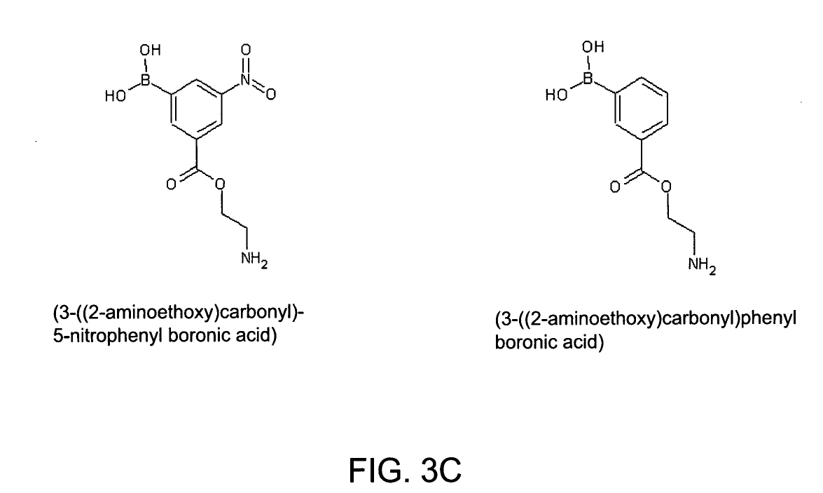

FIGS. 3A and 3B show six exemplary boronic acid chemistries, five of which include thiol groups and one of which includes a silicon group, that can be directly attached to a conductive moveable surface 110 to facilitate glucose detection in accordance with certain embodiments of the present invention. As shown in FIG. 3A, each of 4-mercaptophenyl boronic acid, thiophene-3-boronic acid, and thiol terminated alkane boronic acid is attached to a conductive moveable surface 110, for example, a gold surface. In FIG. 3B, variable length CH₂ chains, e.g. (CH₂)ₙ, and additional moieties, Z, can be used in the boronic acid ligand attached to the conductive moveable surface 110. In certain embodiments, n can represent less than 20, less than 10, and/or less than five CH₂ groups in the chain. In certain embodiments, Z can represent any atom having an optional complement of hydrogen atoms attached to the conductive moveable surface 110. In certain embodiments, Z can represent, for example, O, NH, or CH₂, such that the linkage includes, for example, an ester, amide, ketone, or other moiety.

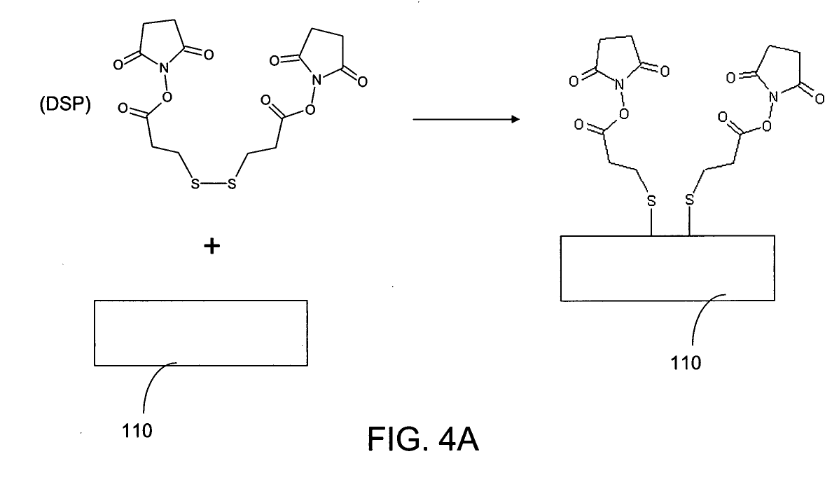

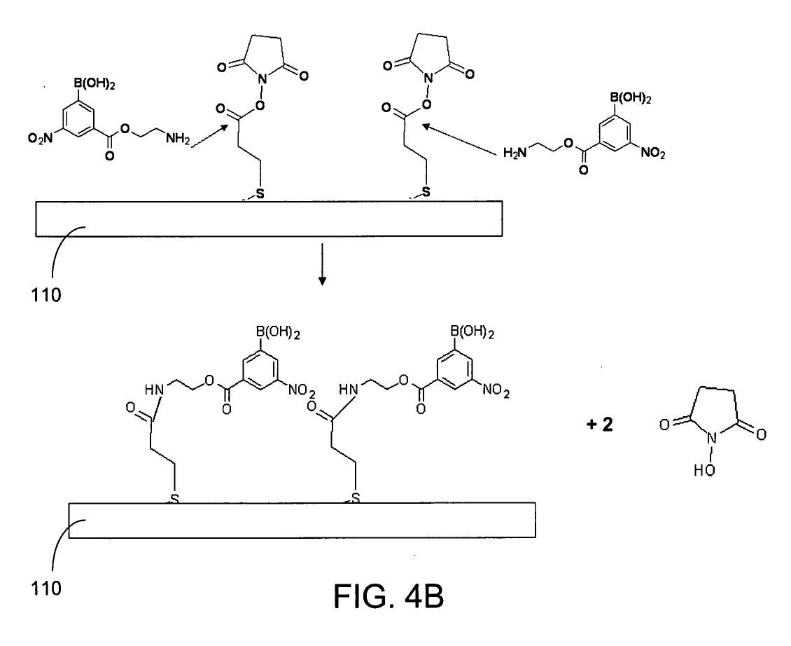

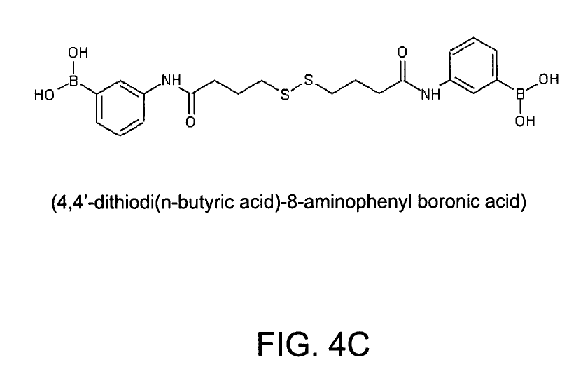

FIG. 3C shows two exemplary boronic acid compounds, 3-((2-aminoethoxy)carbonyl)-5-nitrophenyl boronic acid and 3-((2-aminoethoxy)carbonyl)phenyl boronic acid, that can serve as ligands for glucose detection and which can be attached to a conductive moveable surface 110. Specifically, in certain embodiments, as an alternative to using a thiol group or silicon group to facilitate attachment, an amine group can be used to attach the boronic acid to a metal surface 110 after treatment of the metal surface 110 with DSP, as exemplified by the two-step synthesis depicted in FIGS. 4A and 4B. More specifically, FIG. 4A depicts the formation of a self-assembled DSP monolayer on a conductive moveable surface 110 that includes gold. FIG. 4B depicts the reaction to bind an amino-boronic acid to the DSP self-assembled monolayer. In certain other embodiments, a boronic acid compound can be attached to a conductive moveable surface 110 in a single step. In certain embodiments, a compound having one or more boronic acid moieties and a sulfur-containing group, e.g. a dithiol moiety, such as the compound depicted in FIG. 4C (4,4′-Dithiodi(n-butyric acid)-8-aminophenyl boronic acid), can be immobilized to a conductive moveable surface 110, for example a gold surface, in a single step. For example, the compound depicted in FIG. 4C can be immobilized to a gold surface using a synthesis similar to the step shown in FIG. 4A.

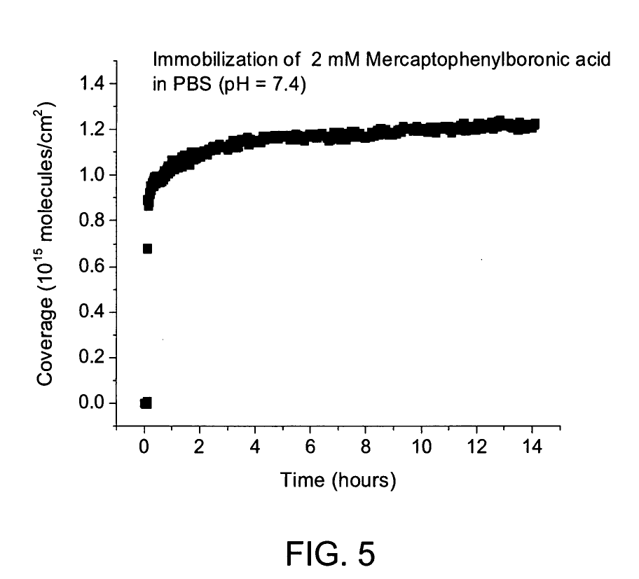

Formation of a boronic acid monolayer on a gold surface 110 can proceed efficiently. For example, the graph depicted in FIG. 5 shows the formation of a self-assembled monolayer as measured by surface plasmon resonance. Time is plotted on the x-axis, while coverage (expressed in units of molecules per area) is plotted on the y-axis. At time=0, the gold surface 110 is exposed to mercaptophenylboronic acid. As shown, the monolayer is created in a matter of hours.

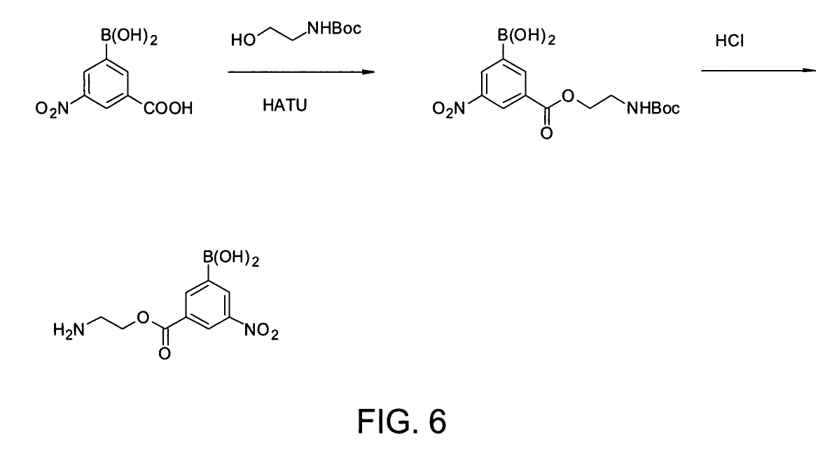

Any boronic acid may be immobilized to the conductive moveable surface 110 by various methods known in the art. For example, in addition to the boronic acids depicted in FIGS. 3A-3C, and 4B, any boronic acid that binds glucose may be bound to the surface 110. In one embodiment, the boronic acid bound to the conductive moveable surface 110 has a significant affinity for glucose at physiological pH (e.g., approximately neutral pH), so that a physiological sample (e.g., blood) is not compromised during sample preparation. FIG. 6 depicts an exemplary chemical synthesis for preparing a boronic acid with an affinity for glucose at physiological pH. As illustrated in FIG. 6, a boronic acid is first reacted to add a Boc-protected amino group. The chemical synthesis in FIG. 6 can by used to produce the compound depicted in FIG. 4B. Then, as shown in FIG. 4B, HCl can then be added to deprotect the amino group in preparation for immobilizing the boronic acid to the surface 110, for example, a surface pretreated with DSP.

As described herein, the regenerable glucose sensor 100 may be used as part of a home test system. The amount of glucose that binds to the boronic acid in the coating 115 may be measured, as described further below, by observing a change in the capacitance of the sensor 100, rather than through the use of labels and/or optical measurements (e.g., fluorescence detection). While fluorescent based glucose detection systems using boronic acids have been developed in the laboratory, they are not amenable to a simple home test system. For example, the synthesis of fluorescently labeled boronic acids is complex. The most common approach for using boronic acid with fluorescence detection is to perform a competitive binding study with a fluorescing diol (Alizarin), which requires titration of a competitive agent. Such competitive binding protocols make it difficult, however, to account for interfering compounds that also bind to immobilized boronic acid.

Non-optical detection of glucose using a boronic acid coated surface 110 is highly sensitive. For example, the capacitance readout of the regenerable glucose sensor 100 depicted in FIG. 1 can detect approximately 2-20 pg/mm² glucose, while a surface plasmon resonance sensor can detect 20 pg/mm² glucose. Accordingly, where the coating 115 of the sensor 100 depicted in FIG. 1 has a surface area of 0.785 mm², to bind 70% of the boronic acid monolayer (i.e., the coating 115) with greater than 50% of the glucose present in a sample requires only 2.2 to 3 nanograms of glucose. At a conservatively typical blood glucose level of 40 mg/dl (usually 40-170 mg/dl), this means that a 1.0 μL to 1.5 μL sample (containing 4-6 ng of glucose) is adequate to conduct a test.

### B. Regenerating the Sensor

In certain embodiments, the sensor system includes a means for regenerating the conductive moveable surface 110, for example by removing bound analyte from ligands of the selective coating 115 that are immobilized to the surface 110. Because glucose reversibly binds to boronic acid, a number of regenerating techniques and reagents can be employed to remove the bound glucose or detected diols from a boronic acid ligand immobilized to the conductive moveable surface 110 of the sensor 100. For example, as mentioned above, excess water can be applied to the conductive moveable surface 110 to hydrolyze the bonds between the diol and boronic acid ligand. Alternatively, an oxidizing agent, such as H₂O₂, can be used to oxidize the bonds. In both of these regenerating scenarios, the detected diol is removed from the boronic acid ligand. Alternatively, the boronic acid ligand can be stored in and regenerated to a state of having an undetected diol attached to it, such as a glycol. For example, ethylene glycol can coat the surface of the boronic acid self-assembled monolayer, being bound approximately one-for-one to each boronic acid ligand on the self-assembled monolayer. When a sample, for example blood, is applied, the diols in the sample, such as glucose, compete with and replace the glycols bound to the boronic acid ligands. To regenerate such a system, an abundance of glycol may be applied to the self-assembled monolayer to replace the diols detected in the sample (e.g., glucose). Generally, washing the boronic acid ligands with a buffer solution that includes ⁻OH can also regenerate a boronic acid-based sensor 100.

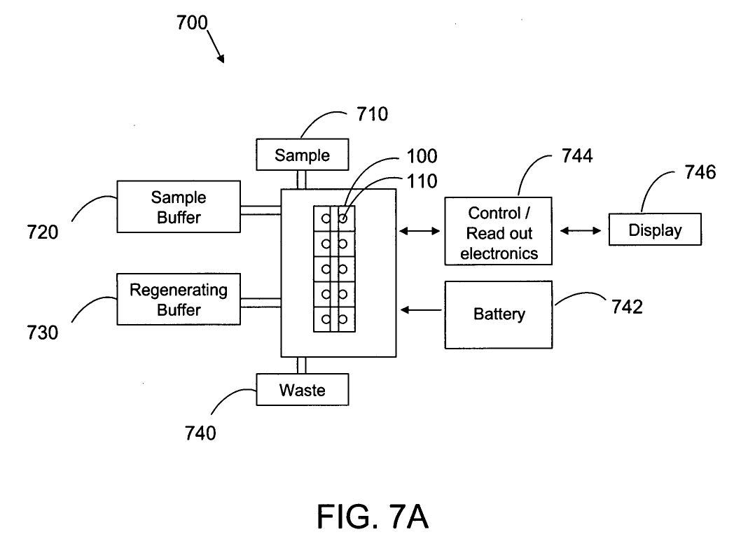

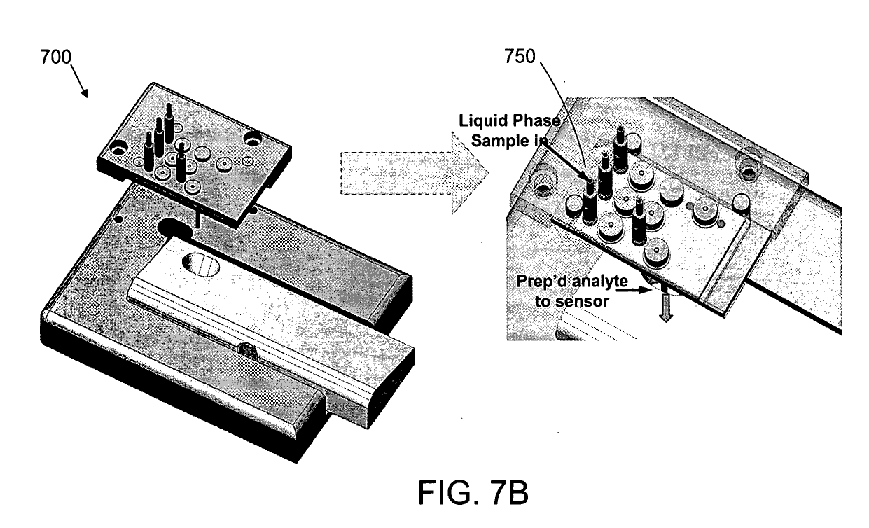

FIGS. 7A and 7B each depict a schematic exemplary overview of a system with regenerable sensors 100 for detecting glucose in a sample. In FIG. 7A, the sensor system 700 includes an access 710 for a sample (e.g., a fluidic port through which blood may be injected), an optional sample buffer 720, a regenerating buffer 730, and waste 740, which may each flow through separate conduits. A battery 742 supplies power to the sensors 100 and other components. Electronics 744 to control the sensors 100 and other components, and a display 746 to communicate results to a user may also be included. The electronics 744 may include a microprocessor or application-specific integrated circuit (ASIC) for performing the calculations and functions described herein. Moreover, the electronics 744 may include or interface with a memory for storing certain values, as described herein.

In other embodiments, various liquids (e.g., the sample 710, sample buffer 720, regenerating buffer 730, and/or waste 740) flow through one or more of the same conduit at different times. For example, in FIG. 7B, both the sample 710 and the regenerating buffer 730 can be injected through the same input port 750. In certain embodiments, approximately 1 μL sample volume is drawn into the system 700 by capillary action. Optionally, the sample 710 can be mixed with the sample buffer 720 using volume controls known in the art to dispense consistent ratios of sample 710 and sample buffer 720. A set volume of sample 710 may then be delivered to the conductive moveable surface 110 of one of the sensors 100.

As depicted in FIG. 7A, the system 700 may include ten regenerable glucose sensors 100 disposed on a single replaceable chip or cartridge. Alternatively, one, two, four, six, eight, or any number of regenerable glucose sensors 100 can be disposed on the replaceable chip or cartridge. The conductive moveable surface 110 of each sensor 100 in the system 700 can include the same binding ligand, different binding ligands with different affinities for each of glucose and a possible interfering compound (as discussed further below in Section D), and/or a combination of binding ligands.

In one embodiment, only up to a monolayer of bound glucose is sensed and, consequently, only a small amount of sample (approximately 1 μL) and regenerating solution is needed. In certain embodiments, the conductive moveable surface 110 exposed to 1 μL of sample 710 is regenerated by a 20× (20 μL) volume of regenerating buffer 730 (e.g., water, an oxidizing agent, a diol with less affinity, and/or an ⁻OH wash). Any of the liquids (e.g., the sample 710, sample buffer 720, regenerating buffer 730, and waste 740) can be stored in a reservoir. Accordingly, a regenerating reservoir that holds only 1 mL of liquid can allow for 50 regenerating rinses (20 μL×50). One or more of the reservoirs can be replaced at the same time that the multi-sensor chip or cartridge is replaced. Alternatively, the sample inlet, and optionally the outlet, can be in continuous communication with a sample source, such as blood. For example, the inlet can be connected to the vein of the individual, with the system 700 performing continuous or periodic measurements of the glucose content of the blood flowing through it to allow for real-time monitoring of an individual's glucose levels. Additional solutions, such as the regenerating buffer 730, can enter the inlet device at intermittent periods via a valve control.

In certain embodiments the sensor system is portable and forms part of a home test system. The home test system may include a housing and one or more sensors connected with electronics for transmission and display of results to a user. In certain embodiments, the device may include one or more boards that may each, or in combination, include a microprocessor, volatile and/or non-volatile memory, circuits, a piezoelectric beeper, custom gaskets, a motor, a fan, and other components. The sensor system may also include a control button, sample and waste access, a battery case, light-emitting diodes that communicate results to a user, and custom embedded software.

### C. Detecting and Measuring Glucose

In one embodiment of a method for measuring glucose in the sample 710, the sample 710 is exposed (e.g., caused to flow over) the coating 115 of the conductive moveable surface 110 of the sensor 100. The surface 110 undergoes a measurable stress in response to the molecular receptor (e.g., boronic acid) of the coating 115 binding to the glucose. As described, the conductive moveable surface 110 may be a flexible membrane or diaphragm.

If stress above a noise threshold is observed, the presence of the glucose in the sample 710 is confirmed. More elaborate measurements can provide further information, e.g., an estimate of the concentration of the glucose. This may be accomplished by monitoring the extent of binding over time, and generally requires some empirically predetermined relationships between concentration and binding behavior. Less than complete equilibrium saturation of coating 115, for example, as reflected by a final reading below the maximum obtainable under full saturation conditions, may offer a direct indication of concentration. If saturation is reached, the time required to achieve this condition, or the time-stress profile (i.e., the change in observed stress over time) may indicate concentration, typically, by comparison with reference profiles previously observed for known concentrations.

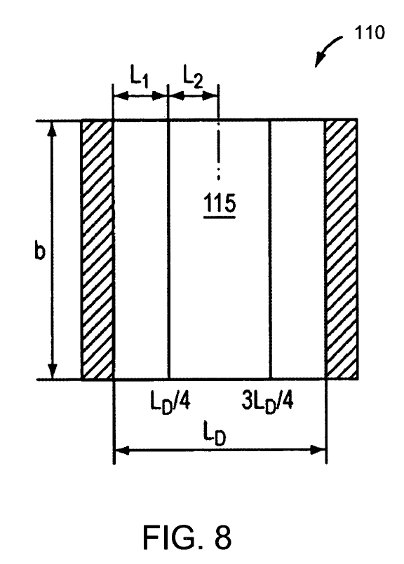

At the same time, knowledge of the dynamics of the behavior of the conductive moveable surface 110 can facilitate measurements even in the absence of reference data. Such knowledge may also dictate design of a device. With reference to FIG. 8, an exemplary approach utilizes a rectangular conductive moveable surface 110 whose length L_{D} is less than half its width b (i.e., b>2L_{D}), and which is secured along all edges. Because the width b is sufficiently greater than the length L_{D}, this configuration may be accurately modeled as a simple beam. Assume, for example, that the conductive moveable surface 110 is made of an elastic material, such as silicon, of thickness hsi, and that the coating 115 has a uniform thickness h_{c}, covers 50% of the area of conductive moveable surface 110, and extends from L_{D}/4 to 3L_{D}/4. Binding of glucose or another analyte, such as another diol, to coating 115 exerts a compressive or tensile stress on the silicon surface 110. Although the stress is probably biaxial, the ensuing beam analysis considers only the lengthwise stress that deflects the conductive moveable surface 110.

A reasonable estimate of the Young's modulus of coating 115 is 1% that of silicon (hereinafter Y_{Si}). As an upper limit on stress, it is assumed that the film can shrink 1% if not restrained; consequently, the stress available for deforming the conductive moveable surface 110 is 10⁻⁴ Y_{Si}.

The axial adhesion axial force may be modeled as a torque couple applied at x=L_{D}/4 and x=3L_{D}/4. In such a case, the torque magnitude is:

M=ε_{c}Y_{c}bh_{c}(y_{c}−yₒₘ) (Equation 1)

where Y_{c} is the coating's Young's modulus (e.g., 1.68×10⁻⁹ N/m²); ε_{c} is the unrestrained strain (0.01); b is the width of conductive moveable surface 110 (the coating 115 traverses the entire width b); h_{c} is the thickness of coating 115 plus analyte (e.g., 10⁻⁹ m, one monolayer coating and one of analyte); and (y_{c}−yₒₘ) is the vertical distance between coating's center and the neutral axis for torque inputs when a pure torque is applied.

With the coating 115 covering the central portion of the conductive moveable surface 110 (L₁=L₂ in FIG. 8), the maximum deflection is:

$${y}_{cen} = \frac{{ML}_{D}^{2}}{8 {R}_{M}} \qquad ( Equation 2 )$$

where L_{D} is the length of the conductive moveable surface 110 (assumed less than 50% b) and R_{M} is the radius of curvature for unit torque (the sum of the YI terms where the inertia products I are calculated about the torque neutral axis). The point force required to deflect the conductive moveable surface 110 center is given by:

$${F}_{cen} = {k}_{cen} {y}_{cen} = \frac{192 {R}_{M}}{{L}_{D}^{3}} {y}_{cen} \qquad ( Equation 3 )$$

The deflections and strains of conductive moveable surface 110 in response to varying loads are straightforwardly determined (indeed, published tables may be employed; see, e.g., R. J. Roark and W. Young, Formulas for Stress and Strain, McGraw-Hill (5th ed. 1975), page 408). Among several cases, values may be tabulated for held and fixed edges where the larger dimension is 1.5 times the smaller dimension. For this situation, the plate can be modeled as very wide (the plane strain assumption) so that the low-pressure results can be compared to tabulated closed-form solutions.

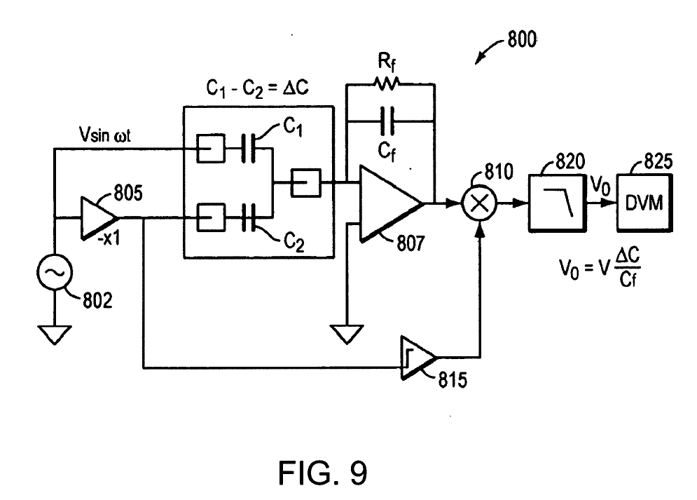

A representative circuit 800 suitable for use in connection with embodiments of the present invention and offering precise capacitance measurements is shown in FIG. 9. Portions of the circuit 800 may form part of the control/readout electronics 744 of the system 700 depicted in FIG. 7A. The circuit 800 may include two regenerable glucose sensors 100, each having an identical baseline capacitance and indicated at C₁, C₂. The capacitance of a single glucose sensor 100 is given by:

$${C}_{s} = \frac{ɛ {bL}_{D} {F}_{sd}}{{g}_{s}} \qquad ( Equation 4 )$$

where ε is the permittivity of free space (8.85×10⁻¹² F/m), gs is the capacitor air gap (e.g., 3 μm), and F_{sd} is the bridge construction factor (e.g., 50%). For efficient design, the counterelectrode 125 should not be built over the conductive moveable surface 110 portion that does not deflect vertically.

In certain embodiments of operation, the measurement devices C₁, C₂ (e.g. sensors and supporting components) are identical but only one (e.g., C₁) is exposed to a sample 710. The other (C₂) is used as a baseline reference, and desirably experiences the same thermal environment as C₁. Alternatively, the reference device may lack a selective coating 115, in which case it, too, may be exposed to the sample 710. One “plate” (i.e., the conductive moveable surface 110) of measurement device C₁ receives a time-varying voltage signal Vsinωt from an AC source 802, and the same plate of measurement device C₂ receives an inverted form of the same signal via an inverter 805. The other plates (i.e., the counterelectrodes 125) of measurement devices C₁, C₂ are connected together and to the inverting input terminal of an operational amplifier 807. Accordingly, if the capacitances of C₁, C₂ were identical, the resulting voltage would be zero due to inverter 805.

Operational amplifier 807 is connected in a negative feedback circuit. The non-inverting terminal is at ground potential, so the output voltage is proportional to the voltage difference: ΔC=C₁−C₂. A feedback resistor R_{f} and a feedback capacitor C_{f} bridge the inverting input terminal and the output terminal of the amplifier 807. The output of amplifier 807 is fed to an input terminal of a voltage multiplier 810. The other input terminal of multiplier 810 receives the output of a device 815, such as a Schmitt trigger, that that produces a rectangular output from the sinusoidal signal provided by inverter 805. When configured in this fashion, multiplier 810 acts to demodulate the signal from amplifier 807, and a low pass filter 820 extracts the DC component from the demodulated signal. The voltage read by the digital voltmeter (DVM) 825 is therefore:

$${V}_{O} = {V}_{rms} \frac{Δ C}{{C}_{f}} \qquad ( Equation 5 )$$

DVM 825 ordinarily includes a display and is desirably programmable, so that the received voltage may converted into a meaningful reading. DVM 825 may allow the user to specify a threshold, and if the sensed voltage exceeds the threshold, DVM 825 indicates binding of the glucose to the coating 115. More elaborately, DVM 825 monitors and stores the voltage as it evolves over time, and includes database relating voltage levels and their time variations to concentration levels that may be reported.

Noting that both an active and reference capacitor are attached to the amplifier inputs, the minimum detectable conductive moveable surface 110 rms position signal is determined by:

$${g}_{res} = {g}_{s} \frac{{V}_{N}}{{V}_{x}} \frac{( 2 {C}_{s} + {C}_{N} + {C}_{fb} )}{{C}_{s}} \sqrt{2 {f}_{band}} \qquad ( Equation 6 )$$

where V_{N} is the preamplifier input voltage noise (e.g., 6 nV/\sqrt{Hz}), Vₓ is the excitation voltage specified as zero to peak, f_{band} is the frequency bandwidth over which measurement is taken (e.g., 1 Hz), C_{fb} is the feedback capacitance (e.g., 2 pF), and C_{N} is the additional capacitance attached to preamplifier input node (e.g., 3 pF). The factor of two under the square root involves the conversion of zero to peak voltages to rms uncertainty. Dividing gᵣₑₛ by the deflection for a monolayer determines the fraction of a layer that can be resolved. The 0-p excitation voltage is desirably set at 50% of the DC snap-down voltage for the conductive moveable surface 110. For this calculation, the counterelectrode 125 is assumed to be rigid. The excitation voltage moves the conductive moveable surface 110 a few percent of the capacitor gap toward the counterelectrode 125. The DC snap-down voltage is calculated according to:

$${V}_{snap} = \sqrt{\frac{8 {k}_{cen} {g}_{s}^{3}}{27 {L}_{D} {bF}_{sd} ɛ}} \qquad ( Equation 7 )$$

Once the glucose or other analyte, such as another diol, reversibly bound to the molecular receptor (e.g., boronic acid) in the coating 115 of the sensor 100 is measured, the conductive moveable surface 110 may be regenerated, as described above in Section B, by removing the glucose or other analyte bound to the coating 115. Further details on the circuit 800 and the relationships between various components of the sensor 100 are described in U.S. Patent Application Publication No. US 2005/0196877 (i.e., U.S. patent application Ser. No. 10/791,108), the contents of which are hereby incorporated herein by reference in their entirety.

Although the method for measuring glucose in a sample has been described with respect to the particular sensor 100 depicted in FIG. 1, those skilled in the art will understand that the methods described herein for detecting glucose reversibly bound to a molecular receptor, such as boronic acid, may also employ other types of sensors that do not require optical detection and/or labeling with an optically-detectable label. For example, in certain embodiments, the sensor surface includes gold, silicon, and/or silicon dioxide, which can facilitate immobilization of a ligand (e.g. a boronic acid ligand).

In certain embodiments, the methods can be performed using small micromachined cantilever sensors and/or flexural plate wave (“FPW”) sensors. For example, a cantilever sensor may convert a chemical reaction and/or interaction at a cantilevered surface into a detectable mechanical stress on the cantilever and then into an electronic or other signal that is observed by a user, for example at a readout display. Specifically, the binding of an analyte, such as glucose, to a molecular receptor, such as boronic acid, coated on the cantilevered surface changes the position of the cantilevered surface, which may be detected by a change in capacitance with respect to a counterelectrode. The mechanical stresses may be detected with a high degree of sensitivity. Cantilever sensors may be manufactured and operated as small instruments, with analytes separated from the electronic and readout mechanisms. The cantilevers are delicate, so selective coatings, such as boronic acid, are applied to the cantilever surface with care.

FPW sensors may employ a conductive moveable surface, such as a diaphragm, that is acoustically excited by interdigitated fingers to establish a standing wave pattern. The diaphragm may be coated with a selective material, such as boronic acid. Interaction of glucose with the boronic acid increases the effective thickness of the diaphragm, thereby affecting the frequency of the standing wave so as to indicate the degree of interaction. FPW sensors may be constructed of conducting, mechanical, and piezoelectric layers. To reduce thermal distortions, the FPW sensors may be run at high resonant frequencies.

### D. Accounting for Interfering Compounds

As described, in certain embodiments, a glucose measurement is obtained by flowing the sample 710 over the selective coating 115, taking a reading of the sensor 100, and regenerating the conductive moveable surface 110 of the sensor 100. However, a sample 710, such as blood, may also include one or more interfering compounds that interfere with the detection of the glucose present in the sample 710. Those interfering compounds may, for example, also bind to the coating 115 on the conductive moveable surface 110 of the sensor 100, and thereby give a false indication of the amount of glucose present in the sample 710. For example, where boronic acid is used in the coating 115 as the molecular receptor for the glucose, other compounds present in a blood sample 710, such as diols, including fructose, other sugars, and/or carbohydrates, may bind to the boronic acid. Fructose, for example, is present at approximately 10% the level of glucose in blood. In addition, other interfering compounds may become a problem if, for example, the sample pH is altered from a physiological pH.

Accordingly, in certain embodiments, the present invention features systems and methods that account for the interaction between one or more interfering compounds and the coating 115 of the sensor 100 so as to accurately determine the amount of glucose present in the sample. Specifically, in certain embodiments, the system 700 described above employs n+1 sensors 100 (the +1 being the reference sensor described in relation to FIG. 9) to account for interference by n−1 interfering compounds. The following example describes a system and method that accounts for fructose interference in a boronic acid-based sensor 100 intended to detect glucose, but any number of interfering compounds (or interfering compounds other than fructose) can be addressed by such a system and method.

More particularly, with reference again to FIG. 7A, a system 700 for determining the amount of glucose present in a sample 710, which includes both the glucose and the interfering fructose, may include first and second sensors 100 (a third, reference sensor, may also be employed). The conductive moveable surface 110 of the first sensor 100 may include a coating 115 of boronic acid that has separate binding constants for each of the glucose and the interfering fructose. The conductive moveable surface 110 of the second sensor 100 may also include a coating 115 of boronic acid that has separate binding constants for each of the glucose and the interfering fructose. However, in one embodiment, the particular boronic acid used with the second sensor 100 is different than the particular boronic acid used with the first sensor 100. The boronic acids are different in that they have a different binding constant for at least one of the glucose and the fructose. For example, at least one binding constant for the boronic acid of the second sensor 100 is different from the corresponding binding constant for the boronic acid of the first sensor 100 (e.g., the boronic acids have different binding constants for the glucose), or at least one binding constant for the boronic acid of the second sensor 100 is different from each binding constant for the boronic acid of the first sensor 100 (e.g., the binding constant to glucose for the boronic acid of the second sensor 100 is different from each of the binding constants to glucose and fructose for the boronic acid of the first sensor 100), or both binding constants for the boronic acid of the second sensor 100 are different from both binding constants for the boronic acid of the first sensor 100 (e.g., each of the binding constants to glucose and fructose for the boronic acid of the second sensor 100 is different from each of the binding constants to glucose and fructose for the boronic acid of the first sensor 100). These different binding constants may be stored in a memory of the system 700, which may form part of the control/readout electronics 744.

The response of each of the first and second sensors 100 (e.g., the detected amount of deformation of their respective conductive moveable surfaces 110, which may be measured as a change in capacitance) is proportional to the total amount of analyte (e.g., glucose and fructose) that binds to the selective coating 115 of the sensor 100. The proportionality correlation can be determined by standard calibration techniques known in the art. Accordingly, in an embodiment of a two-sensor system 700 (which may also employ a third, reference sensor), the response (S1) of sensor 1 is proportional to the total of the glucose concentration (G) and fructose concentration (F). The same is true for the response (S2) of sensor 2, except that the lumped binding constants are different. In one embodiment, both sensors 1 and 2 are exposed substantially simultaneously to the same sample 710 that includes the glucose and fructose, such that F and G have the same values for both sensors 1 and 2.

Accordingly, the responses S1 and S2 of the sensors 1 and 2 are a function of the binding constants (k1-k4), as follows:

S1=k1G+k2F (Equation 8)

S2=k3G+k4F (Equation 9)

To measure the glucose concentration, it is not necessary to have preferential binding for glucose by either sensor 1 or 2; one or more binding constants k1-k4 only need to be different as described above. The binding constants k1-k4 may be calculated prior to detection by known methods, for example calibration of glucose and fructose standards using the same conditions as in the detection, and stored in the memory of the control/readout electronics 744. Then, responses S1 and S2 may be measured, for example as a change in capacitance of each of the sensors 1 and 2 as previously described, during detection. Equation 8 may then be solved for F, as follows:

F=(S1−k1G)/k2 (Equation 10)

Substituting the value of F from Equation 10 into Equation 9 yields:

S2=k3G+k4(S1−k1G)/k2 (Equation 11)

This allows for the determination of the glucose concentration, G, as follows:

S2=k3G+k4S1/k2−k4k1G/k2 (Equation 12)

k4k1G/k2−k3G=k4S1/k2−S2 (Equation 13)

G(k4k1/k2−k3)=k4S1/k2−S2 (Equation 14)

G=(k4S1−S2k2)/(k4k1−k3k2) (Equation 15)

Accordingly, in this way, any number n of interfering compounds can be accounted for and quantified in a glucose detection system 700.

### Incorporation by Reference

The entire disclosure of each of the publications, patent documents, and other references referred to herein is incorporated herein by reference in its entirety for all purposes to the same extent as if each individual source were individually denoted as being incorporated by reference.

### Equivalents

The invention may be embodied in other specific forms without departing form the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

What is claimed is:

1. A regenerable sensor for measuring glucose in a sample, comprising:
a diaphragm comprising a conductive portion;
a molecular receptor, capable of reversibly binding to the glucose, coated on a first face of the diaphragm; and
a counterelectrode spaced from and in opposition to the diaphragm, wherein the diaphragm deforms and thereby alters a capacitance of the regenerable sensor upon binding of the glucose to the molecular receptor.

2. The regenerable sensor of claim 1 further comprising means for regenerating the first face of the diaphragm by removing the glucose bound thereto.

3. The regenerable sensor of claim 1 further comprising means for introducing blood to the first face of the diaphragm.

4. The regenerable sensor of claim 1, wherein the molecular receptor comprises a boronic acid.

5. The method of claim 1, wherein the diaphragm comprises a material selected from the group consisting of gold and silicon.

6. A method for measuring glucose in a sample, the method comprising:
exposing the sample to a sensor that comprises boronic acid bound to a moveable surface of the sensor;
measuring the glucose reversibly bound to the boronic acid; and
following the measuring, regenerating the moveable surface by removing the glucose bound to the boronic acid.

7. The method of claim 6, wherein regenerating the moveable surface comprises flowing a buffer solution over the moveable surface.

8. The method of claim 6, wherein regenerating the moveable surface comprises exposing the moveable surface to a glycol.

9. The method of claim 6, wherein regenerating the moveable surface comprises oxidizing the glucose bound to the boronic acid.

10. The method of claim 6, wherein measuring the glucose comprises observing a deformation of the moveable surface.

11. The method of claim 6, wherein measuring the glucose comprises observing a change in capacitance of the sensor.

12. The method of claim 6, wherein the sample comprises blood.

13. A method for determining an amount of glucose in a sample that comprises the glucose and an interfering compound, the method comprising:
exposing the sample to a first sensor comprising a first molecular receptor capable of binding the glucose and the interfering compound;
exposing the sample to a second sensor comprising a second molecular receptor capable of binding the glucose and the interfering compound, the second molecular receptor having a different binding constant than the first molecular receptor for at least one of the glucose and the interfering compound;
measuring a total amount of glucose and interfering compound bound to each of the first molecular receptor and the second molecular receptor; and
based thereon, calculating the amount of glucose in the sample.

14. The method of claim 13, wherein at least one of the first and second molecular receptors comprise boronic acid or a derivative thereof.

15. The method of claim 13, wherein the measuring comprises measuring a change in capacitance of each of the first and second sensors.

16. The method of claim 13, wherein the sample comprises blood.

17. The method of claim 13, wherein the interfering compound is a sugar other than glucose.

18. A system for determining an amount of glucose in a sample that comprises the glucose and an interfering compound, the system comprising:
a first sensor comprising a first surface having separate binding constants for each of the glucose and the interfering compound; and
a second sensor comprising a second surface having separate binding constants for each of the glucose and the interfering compound, at least one binding constant for the second surface being different from the corresponding binding constant for the first surface.

19. The system of claim 18, wherein at least one of the first sensor surface and the second sensor surface is a moveable surface.

20. The system of claim 19, wherein the moveable surface comprises a conductive portion.

21. The system of claim 19 further comprising boronic acid or a derivative thereof coated on the moveable surface.

22. The system of claim 21, wherein interaction of the boronic acid or the derivative thereof with the glucose and the interfering compound deforms the moveable surface.

23. The system of claim 22, wherein the deformation of the moveable surface is measured as a change in capacitance of the sensor.

24. The system of claim 18 further comprising memory for storing binding constants of the glucose and the interfering compound.

25. The system of claim 18 further comprising circuitry for calculating the amount of glucose present in the sample.

26. A ligand for use in a glucose sensor, the ligand comprising the chemical structure

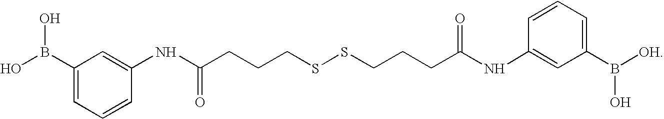

27. A ligand for use in a glucose sensor, the ligand comprising the chemical structure [chemical structure]
